(19) United States
(12) Patent Application Publication
(10) Pub. No.: US 2003/0161983 A1
(43) Pub. Date: Aug. 28, 2003

(54) Decorative article

(75) Inventors: Guilhem Rousselet, Paris (FR); Jean-Pierre Lion, Laval (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: L'OREAL, Paris (FR)

(21) Appl. No.: 10/345,185

(22) Filed: Jan. 16, 2003

(30) Foreign Application Priority Data
Jan. 16, 2002 (FR) 0200489

(51) Int. Cl. B32B 9/00; B32B 31/00

(52) U.S. Cl. 428/40.1; 156/269; 156/279; 156/289

(57) ABSTRACT

A decorative article (10) that may be applied to the skin, having a support (11) having a first face (12) flock coated, and a second face (14), opposite to the first, coated with an adhesive layer (15). One face of the adhesive layer, facing away from the support, may be put in contact with the skin. Support (11) is permeable to the glue used for the flock coating of the first face (12).

This application claims priority to French patent application 0200489 filed on Jan. 16, 2002, incorporated herein by reference.

### SUMMARY OF THE INVENTION

The present invention relates to a decorative article that may be applied to the skin, comprising a support having a first face that is flock coated, and a second face, opposite to the first, coated with an adhesive layer. The face of the adhesive layer, facing away from the support, may be put in contact with the skin. In the invention, the support is permeable to the glue used for the flock coating of the first face. Preferably the support is flexible.

In a preferred embodiment the present invention provides an article that can be used for decorative purposes on the skin, in particular on the face, or on any other part of the body. Such decorative articles can be used in addition to make-up obtained with conventional cosmetic products, in particular on the lips, cheeks or eyes. Such decorative articles can be used like a beauty spot, or consist of a pattern, in particular a rose or any other figurine.

The invention will be better understood by reference to the following background, objects and detailed description thereof.

### BACKGROUND OF THE INVENTION

Decorative articles are known. They generally comprise a support made from polyvinyl chloride (PVC) or from a high-density non-woven material, having one face flock coated and the other face comprising a glue for fixing the article to the skin.

For manufacturing these known articles, the starting point is generally a self-adhesive sheet of PVC, the adhesive face of which is covered with a removable protective film. The face of the adhesive sheet opposite to the protective film is then flock coated in a suitable manner.

Conventionally, the flock coating is carried out by coating the face to be flock coated with a glue and depositing thereon the fibers of flock coating material by means of an electrostatic process. From such a process there results an orientation of the fibers substantially perpendicular to the plane of the surface to be flock coated.

In the context of such a process, the use of a material impermeable to the glue used for the flock coating is made obligatory by the fact that, if such an impermeable material is not used, the flock-coating glue would pass through the support and would be liable to at least partly dissolve the glue of the adhesive face to the point that good cohesion would no longer be ensured between the adhesive face and the protective film.

From this necessary impermeability of the support, there results a low elasticity and a certain rigidity of the decorative article, the rigidity being appreciably prejudicial to the comfort of the person to whom the decorative article is applied. This is because this certain rigidity results in a relatively high resistance of the object being shaped to the contours of the face or the part of the body on which the object is placed. The low elasticity for its part results in a relatively high resistance of the object to deforming longitudinally, and therefore to accompanying the longitudinal deformations of the skin during movements of the face or of the part of the body on which the object is placed.

This sensation of discomfort is also increased by a not insignificant “weight” of the decorative article, due to the high density of the support (typically greater than 100 g/m²).

Quite obviously, the problem relating to such a rigidity is not posed when, as in FR-A-2 221 925, the article is intended principally for being applied to an article of clothing or to any other object. According to this document, the material forming the support is a woven or non-woven material. The preferred embodiment of this document is an article applied by means of an iron, which requires the support to have a certain density failing which it would not withstand the temperatures required for the heat bonding. With such a density, the support is impermeable to the flock-coating glue. The article resulting therefrom is of limited flexibility and elasticity.

### OBJECTS OF THE INVENTION

One object of the invention is a decorative article that can be applied to the skin, preferably to the face, which addresses the problems discussed above with reference to conventional articles.

Another object of the invention is a decorative article which has substantially improved comfort for the person wearing it.

Another object of the invention is a decorative article which is economical to produce.

Yet another object of the invention is an economical and reliable process for producing a decorative article according to the invention.

### BRIEF DESCRIPTION OF THE DRAWINGS

FIGS. 1 and 2 depict a set of decorative articles according to a preferred embodiment of the invention;

FIGS. 3-6 illustrate in a simplified fashion the steps of manufacturing the set depicted in FIGS. 1 and 2.

### DETAILED DESCRIPTION OF THE INVENTION

According to a first aspect of the invention, the above objects are achieved by the provision of a decorative article that may be applied to the skin, comprising a support having a first face flock coated and a second face, opposite to the first, coated with a self-adhesive layer, wherein a face of the adhesive layer which faces away from the support may be put in contact with the skin, and wherein the support is permeable to the glue used for the flock coating of the first face. Preferably the support is flexible.

The use of a support having such permeability generally provides a great flexibility to the decorative article. Because of this, the comfort of the person wearing it is substantially improved. The sensations of tugging felt with prior art decorative articles of the type discussed above are attenuated to a very great extent. In addition, the skin breathes. This characteristic is particularly advantageous when the pattern corresponding to the decorative article has a relatively large surface area.

This permeability results not only from the choice of the material but also from the configuration of the support. Thus, when the support is produced from a non-woven material, it is necessary to choose a sufficiently low density for it to allow the required permeability.

The support is preferably a non-woven material whose density is from 50 g/m² to 100 g/m², and preferably from 60 g/m² to 90 g/m², these ranges including all values and subranges therebetween as if specifically written out. By way of specific example, a preferred non-woven material is one based on cellulose and/or polyester whose density is approximately 80 g/m². The synthetic fibers forming the support preferably have a homogeneous distribution and are preferably strongly bonded together by a synthetic polymer providing the strength of the support when it is coated with the aqueous emulsion intended for the gluing of the flock.

The thickness of the support is not particularly limited and can preferably be from 0.1 mm to 0.8 mm, more preferably from 0.15 mm to 0.40 mm, and still more preferably from 0.15 mm to 0.3 mm, and even more preferably may be around 0.2 mm (these ranges including all values and subranges therebetween as if specifically written out).

Advantageously, prior to the application of the article to the skin, the face of the adhesive layer facing away from the support is covered with a removable protective film. A preferred protective film is silicone-coated paper.

The flock coating can for example comprise fibers of cotton, rayon, polyamide or viscose or a mixture of such materials. Yet other materials may be used. The fibers are preferably distributed uniformly over the glued surface of the support, and are preferably implanted by an electrostatic process. After implantation in the resin, the fibers are preferably fixed by drying and polymerization. The quantity of fibers per unit surface area is not particularly limited and may for example be around 30 to 45 g/m², this range including all values and subranges therebetween as if specifically written out.

The glue intended for the flock coating is not particularly limited and may for example be based on polyacrylic or polyvinyl resin. More preferably, a resin is used from the family of ester-acrylics in aqueous dispersion. By way of non-limiting example, the resin may be deposited in a quantity, in terms of dry matter, of from 50 to 90 g/m² this range including all values and subranges therebetween as if specifically written out.

The adhesive layer preferably comprises a hypoallergenic glue, for example a glue as used for the manufacture of adhesive coatings used in the medical field. By way of example, use may be made of a glue sold under the commercial reference TIVOCOLLO® 4771/04 by the company SIKA TIVOLI FRANCE. The adhesive can be deposited at any operational density, such as 60 to 80 g/m², this range including all values and subranges therebetween as if specifically written out. In one embodiment, the adhesive may preferably be deposited on an anti-adherent support, for example of the silicone-coated paper type, and then fixed thermally and applied by contact and pressure to the face of the support opposite to the flock coating.

The total thickness of the decorative article according to the first aspect of the invention (without any silicone-coated protection) is not limited and may for example be from 0.4 mm to 0.8 mm, and preferably from 0.5 to 0.7 mm, as measured under a weight of 15 g/cm², these ranges including all values and subranges therebetween as if specifically written out.

The total weight of the decorative article thus manufactured is not particularly limited and may be for example from 200 to 300 g/m², this range including all values and subranges therebetween as if specifically written out.

According to a second aspect of the invention there is provided a set of decorative articles comprising a protective film on which a plurality of decorative articles according to the first aspect of the invention are disposed.

Such a set may be in any geometrical form and dimension, such as in the form of a rectangular sheet of approximately 10 cm² on which there is disposed a plurality of decorative patterns, preferably evenly spaced apart. The decorative patterns in the set may be identical or different. Such patterns may in particular be in the form of small discs a few millimeters in diameter, so as to form beauty spots to be applied to the face.

According to a third aspect of the invention there is provided a process comprising:

i) flock coating a first face of a sheet of a support, by means of fibers fixed to the first face, using a glue to which the support is permeable;

ii) rendering adhesive a second face of the support, opposite to the first, by means of an adhesive layer having a face which is intended to be put in contact with the skin and optionally covered with a removable protective film; and

iii) optionally cutting the flock-coated support so as to delimit a plurality of decorative articles.

Advantageously, the process also comprises:

iv) optionally separating the support sheet from the protective film at points external to the decorative articles.

Thus, in spite of the permeability of the support, the cohesion between the protective film and the support is not affected by the flock-coating glue since the flock-coating operation is performed prior to the placing of the protective film, the latter operation occurring only after drying of the flock-coating glue. Preferably the flock-coating glue is allowed to dry prior to step ii) above where “allowed to dry” includes active drying (such as heating) and passive drying (such as standing at ambient temperature).

Preferably, prior to step iv), the adhesive layer is neutralized at least at certain points external to the decorative articles. In this way the separation of the support sheet and protective film at points other than the decorative patterns is facilitated. Removing them also from the protective film during this separation step is avoided, in particular when they have a small surface area. This neutralization step preferably occurs before the cutting operation.

Alternatively the glue can be applied only at certain points, in a pattern chosen according to the arrangement of the decorative articles, so as to be able to dispense with this neutralization step.

This neutralization can be carried out for example by applying a suitable composition, in particular a lacquer, at the required points. In a preferred example, a neutralizing lacquer sold by Akzo is applied. Alternatively, one or more strips of a material are applied, which are interposed at the required points, between the flock-coated support and the protective film.

The invention will be further explained below, with regard to non-limiting example embodiments, described with reference to the accompanying drawings.

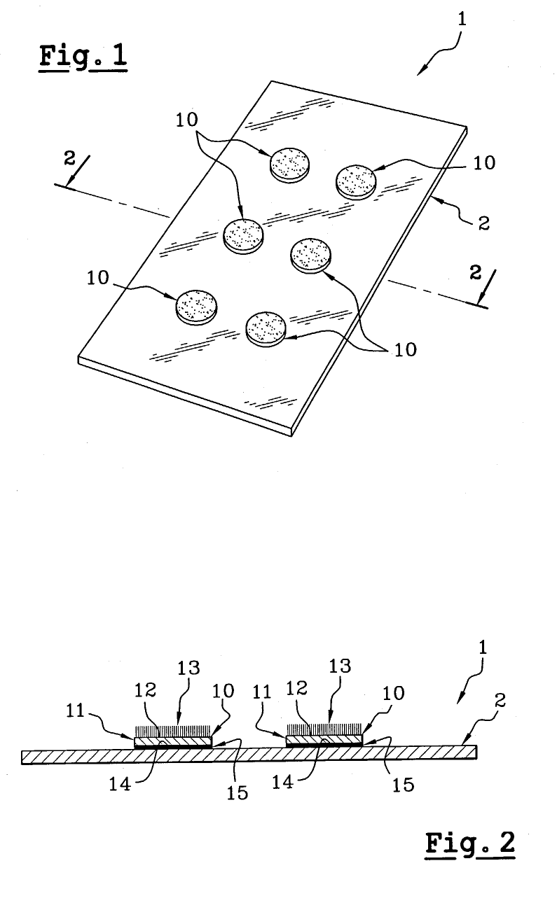

The set 1 depicted in FIGS. 1 and 2 comprises a sheet of silicone-coated paper 2 whose density is 80 g/m². The sheet 2 is rectangular and its surface area is approximately 10 cm².

On the sheet 2 there are disposed two rows of three decorative articles 10 which will be discussed in detail below. Such decorative articles are configured in the form of small discs with a brown or black color, whose diameter is around 3 to 4 mm.

As is clear from the view in section in FIG. 2, each decorative article 10 comprises a support 11 made from non-woven material based on polyester and cellulose. Its thickness is around 0.2 mm.

One face 12 of the support 11 is covered with a flock coating 13 based on viscose fibers. The density of the flock coating 13 is around 40 g/m². The length of the flock-coated fibers is around 0.3 mm. Their diameter is around 0.9 decitex.

The face 14 of the support opposite to the face 12 is coated with an adhesive layer 15 formed by a hypoallergenic glue. The face of the adhesive layer 15 remote from the support 11 is in contact with the sheet of silicone-coated paper 2.

In use, the user removes from the paper 2 the article or articles 10 which he or she wishes to apply and applies it by simple pressure to the required place.

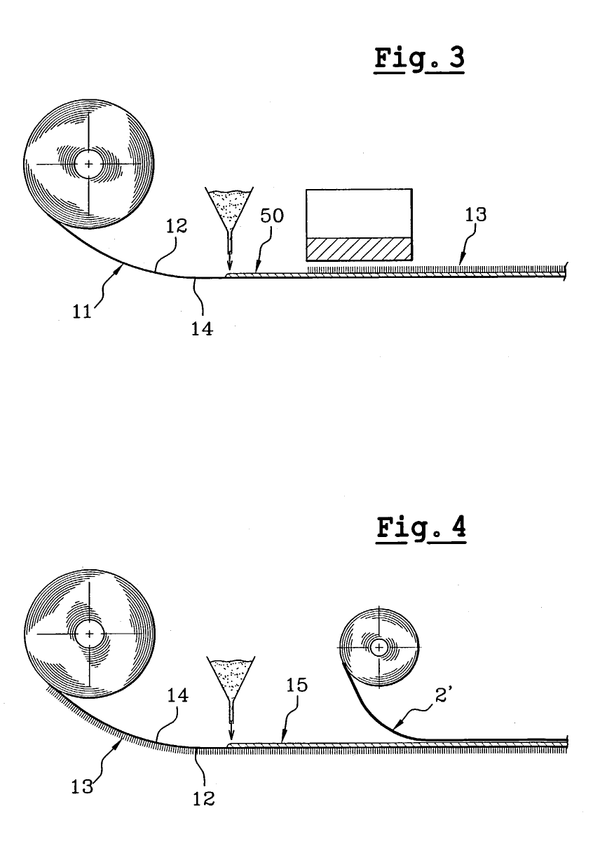

FIGS. 3-6, to which reference is now made, illustrate one embodiment of an invention process wherein the main steps of manufacturing an assembly as depicted in FIGS. 1 and 2 are shown.

In FIG. 3, on the face 12 of a support made from non-woven material 11, there is deposited a layer of acrylic glue 50 in the form of an aqueous emulsion, on which there is deposited electrostatically a flock coating 13 consisting of viscose fibers whose length is around 0.3 mm. The density of the flock coating 13 is approximately 40 g/m². The support 11 thus flock coated is, after a drying and polymerization step (not shown), wound on a spindle, the flock-coated face 12 being turned towards the outside of the core.

In FIG. 4, there is deposited on the face 14 opposite to the flock coating 13 a layer of a hypoallergenic adhesive 15 used in a conventional manner in the medical field, the layer of adhesive being covered with a sheet of silicone-coated paper 2′.

In practice, and in a little more detail, the self-adhesive layer 15 is in reality deposited on the sheet of silicone-coated paper 2′. It is fixed thermally and applied by contact and pressure to the face 14 of the support.

The assembly thus formed is once again wound on a spindle.

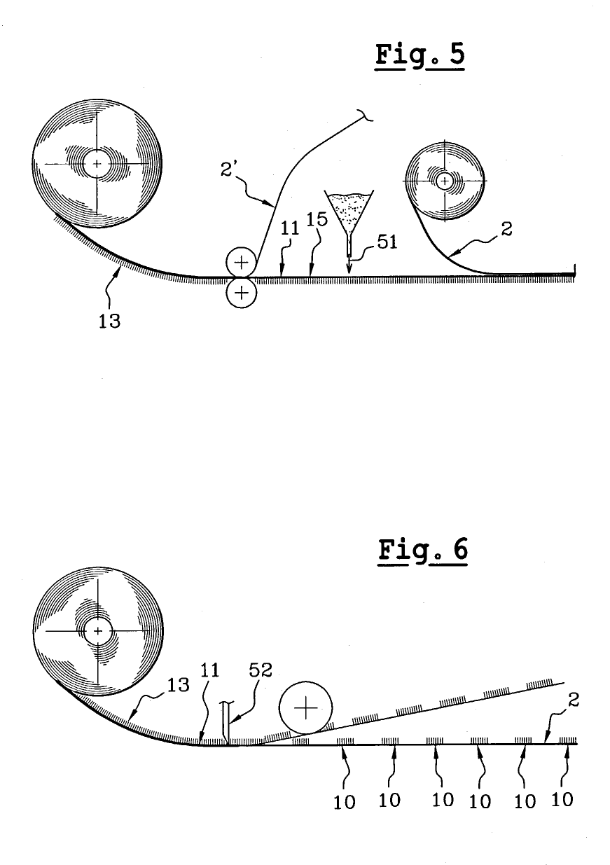

In FIG. 5, the protective sheet 2′ is separated from the flock-coated support 11.

The adhesive layer 15 is neutralized along one or more strips (or in accordance with any other suitable pattern) corresponding to portions of the assembly 1 not comprising any decorative article 10. For this purpose, a lacquer 51 able to neutralize the adhesive of the layer 15 is deposited.

On the thus partially neutralized layer 15 a protective sheet 2 of silicone-coated paper is deposited (which may or not be the one 2′ which was previously removed). The strip is once again wound on a spindle.

In FIG. 6, by means of a suitable cutting tool 52, the support 11 is cut to the shape of the patterns to be produced 10, without affecting the protective sheet 2. The support portions situated outside the patterns to be produced 10 are then separated from the protective sheet 2. On the latter, there remain only the decorative articles 10 evenly spaced apart. The strip is then cut to the chosen format so as to comprise the required number of decorative articles 10.

In the embodiment, the various operations have been illustrated sequentially, with winding of the strip after each operation. This embodiment is particularly suitable when the various operations are performed by various participants. It is clear that, with a suitable industrial tool, all these operations can be carried out continuously.

In the above detailed description, reference was made to preferred embodiments of the invention. It is obvious that variants can be made thereto without departing from the spirit of the invention as claimed hereinafter.

The above description of the invention sets forth the manner and process of making and using it, and fully enables one of skill in the art to which it pertains to make and use the embodiments set forth in the following claims, and the following preferred embodiments, all of which make up a part of this description:

a decorative article intended to be applied to the skin, comprising a support, preferably a flexible support, having a first face flock coated, and a second face, opposite to the first, coated with an adhesive layer, wherein one face of the adhesive layer, which faces away from the support, is intended to be put in contact with the skin, wherein the support is permeable to the glue used for the flock coating of said first face.

a process of manufacturing a set of decorative articles, wherein it comprises:

i) flock coating a first face of a sheet of a support, by means of fibers fixed to said first face, using a glue to which the support is permeable; and

ii) rendering adhesive a second face of the support, opposite to the first, by means of an adhesive layer having a face of which is intended to be put in contact with the skin, and is covered with a removable protective film; and

iii) cutting the flock-coated support so as to delimit a plurality of decorative articles,

optionally further comprising:

iv) separating the support sheet from the protective film at points external to said decorative articles.

All references, texts, patents, applications, documents, tests, articles, etc., mentioned above are incorporated herein by reference.

1. A decorative article comprising a support having a flock coated first face, and a second face, opposite to the first, coated with an adhesive layer, wherein the support is permeable to a glue used for the flock coating of said first face.

2. The decorative article according to claim 1, wherein the support comprises a non-woven material whose density is 50 g/m² to 100 g/m².

3. The decorative article according to claim 1, further comprising a removable protective film covering a face of the adhesive layer which faces away from the support.

4. The decorative article according to claim 1, wherein the support comprises a non-woven material.

5. The decorative article according to claim 1, wherein the flock coating comprises fibers of cotton, rayon, polyamide or viscose, or a mixture thereof.

6. The decorative article according to claim 1, wherein the flock coating glue comprises a polyacrylic or polyvinyl resin.

7. The decorative article according to claim 1, wherein the adhesive layer comprises a hypoallergenic glue.

8. The decorative article according to claim 3, wherein the removable protective film comprises a sheet of silicone-coated material.

9. The decorative article according to claim 1, wherein a face of the adhesive layer which faces away from the support is suitable for contact with the skin.

10. The decorative article according to claim 1, wherein the support comprises a non-woven material whose density is 60 g/m² to 90 g/m².

11. The decorative article according to claim 1, wherein the support comprises cellulose or polyester.

12. The decorative article according to claim 1, wherein said support is flexible.

13. A set of decorative articles comprising a protective film on which there is disposed a plurality of decorative articles according to claim 1.

14. A set of decorative articles comprising a protective film on which there is disposed a plurality of decorative articles according to claim 2.

15. A set of decorative articles comprising a protective film on which there is disposed a plurality of decorative articles according to claim 4.

16. A set of decorative articles comprising a protective film on which there is disposed a plurality of decorative articles according to claim 5.

17. The set according to claim 13, wherein said decorative articles are identical to one another.

18. A process of manufacturing a set of decorative articles according to claim 13, comprising:
i) flock coating a first face of a support sheet with glue and fibers, wherein said support is permeable to said glue, and allowing said glue to dry;
ii) applying an adhesive layer to a second face of the support, opposite to the first, which adhesive layer is optionally covered with a removable protective film; and
iii) cutting the flock-coated support so as to delimit a plurality of decorative articles.

19. The process according to claim 18, further comprising:
iv) separating the support sheet from the protective film at points external to said decorative articles.

20. The process according to claim 19, further comprising, prior to step iv), neutralizing the adhesive layer at least at certain points external to said decorative articles.
